(19) United States
(12) Patent Application Publication
(10) Pub. No.: US 2007/0240928 A1
(43) Pub. Date: Oct. 18, 2007

(54) COMPACT CONSTRUCTION VEHICLE WITH IMPROVED MOBILITY

(76) Inventors: W. Craig Coltson, Rockwood (CA); Ioan Sorin Albu, Bolton (CA)

Correspondence Address: BERESKIN AND PARR, 40 KING STREET WEST, BOX 401, TORONTO, ON, M5H 3Y2, US

(21) Appl. No.: 11/735,089

(22) Filed: Apr. 13, 2007

Related U.S. Application Data
(60) Provisional application No. 60/791,452, filed on Apr. 13, 2006.

(51) Int. Cl. B62D 11/24

(52) U.S. Cl. 180/411; 180/6.24

(57) ABSTRACT

A loader type construction vehicle includes a chassis having a longitudinal axis, a plurality of wheeled ground-engaging structures pivotally coupled to the chassis, and a steering control system. Each of the plurality of ground-engaging structures includes a wheel pivotable about a steering axis and drivable about a drive axis, wherein each of the wheeled ground-engaging structures is shaped and configured so that the wheel of each of the ground-engaging structures can be pivoted from a first angular position in which the drive axis is perpendicular to the longitudinal axis, to a second angular position that is at least 90° degrees from the first angular position. The steering control system is operatively connected to each of the ground engaging structures for pivoting the wheel of each of the ground-engaging structures about the steering axis. The steering system may be operable to selectively configure the ground engaging structures into a plurality of different steering configurations, such as crab steering and side steering. The loader vehicle may include a telescopic loader arm.

### RELATED APPLICATIONS

This application claims priority from U.S. provisional application Ser. No. 60/791,452.

### FIELD OF THE INVENTION

The present invention relates generally to compact construction vehicles and more particularly to the mobility and working reach of compact loader type construction vehicles.

### BACKGROUND OF THE INVENTION

Compact loader type construction vehicles are common and popular vehicles used in the construction industry. One of the most common variations is the compact skid steer loader.

Skid steer loaders were first developed approximately 30 to 40 years ago to fill the requirement for a highly maneuverable construction vehicle capable of digging, lifting, transporting and loading earth, gravel and other construction materials. Compact skid steer loaders are typically small with a length of approximately 10-12 feet, and a narrower width.

The most common form of compact skid steer loaders have two fixed length loader arms mounted on the vehicle structure and pivotable in the vertical direction to allow for the lifting and lowering of a variety of work implements connected to the distal end of the loader arms. The most widely recognized work implement is the loader bucket, which allows the vehicle operator to dig, lift, transport and otherwise load any number of different materials, including materials common to construction sites, such as particulate type construction materials (e.g. sand, earth and gravel, etc.).

While the dual loader arm configuration provides the skid steer loader the ability to dig and load, the extent to which the work implement can be utilized forwardly of the front of the vehicle is limited to the reach afforded by the fixed length loader arms. To accurately position a work implement such as a loader bucket or post-hole auger in the desired work position, the vehicle must be carefully maneuvered into a fairly precise location in order for the work implement to be usable in the desired work position. While in some situations there is adequate room in the work area to easily maneuver the vehicle as needed, in many cases the work area is sufficiently confined that it becomes difficult to maneuver even compact skid steer loaders as needed.

This problem can be aggravated by the wheel configuration on most skid steer loaders. In their most common form, compact skid steer loaders have two wheels on the left side of the vehicle and two wheels on the right side of the vehicle. For convenience and to provide a common frame of reference, left and right are described from the perspective of an operator who is sitting in the loader and looking forward. The wheels on each of the left and right sides of the vehicle can be driven and controlled independently from the wheels on the other side of the vehicle.

This independent control of the wheels on each side of the vehicle allows the wheels on each side to turn at different speeds and also in different directions. When all wheels are rotating in the same direction (e.g. in a forward or reverse direction), varying the speed of the wheels on each side of the vehicle allows the vehicle to turn left or right while moving in either a general forward or reverse direction. This allows the vehicle to make relatively smooth and gentle turns without the need for a steering mechanism (such as a rack and pinion or linkage) to actually pivot the front or rear wheels of the vehicle.

However, turning in this manner is not always desirable for working in a confined work space, as the resulting turning radius can be quite large relative to the size of the vehicle. As a result, it becomes difficult using this type of steering to maneuver the vehicle as desired to properly position the work implement.

Alternatively, because the wheels on each side of the vehicle are independently driven, the wheels on each side can be rotated in opposite directions relative to each other. For example, the wheels on the right side can be driven in a forward direction while the wheels on the left side can be driven in a rearward or reverse direction. This will result in the vehicle turning in a generally counter-clockwise direction (from the perspective of a person positioned about the vehicle and looking down at the vehicle) about a vertical axis located proximate the center point of the vehicle, effectively turning in place. This as also known as making a “zero radius turn” or “skidding”. This type of steering allows skid steer vehicles to more easily maneuver within some confined spaces on a worksite, and is one of the reasons that skid steer vehicles have become a desired vehicle for construction work.

However, skid steer vehicles driven in either steering mode still have a number of undesirable characteristics. Most notably, the action of the wheels rotating in opposite directions can impart significant skidding stresses at the interface between the wheels of the vehicle and the ground surface on which the vehicle is moving. These skidding stresses tend to tear the terrain over which the vehicle travels or result in increased wear on the wheels. For instance, when a skid steer vehicle is used on soft surfaces that are common on construction sites (such as grass or muddy fields), the surfaces can quickly become torn up. Any grass or other organic matter contacted by the wheels of a skid steer vehicle tends to be rapidly destroyed. If the vehicle moves repeatedly in one particular area, this can also result in the formation of large ruts caused by the action of the tires. The overall result is a generally undesirable amount of damage to property.

Furthermore, when used on harder surfaces, such as asphalt or concrete, rotating the wheels in opposite directions or “skidding” of the wheels can cause increased rates of wear to the tires on the vehicle, which can result in poor performance and increased operating costs.

One further problem presented by conventional skid steer vehicles relates to their performance on uneven terrain. Skid steer vehicles commonly employ four ground-contacting wheels that are rigidly fixed to the vehicle structure. While this provides generally acceptable performance characteristics when the vehicle is used on even ground, when the skid steer vehicle is used on uneven terrain, one wheel of the vehicle tends to lift off the ground and lose traction. This can lead to instability during use of the skid steer, which is dangerous when the operator is using the work implement, and also makes the skid steer loader more difficult to carefully maneuver. Furthermore, this problem tends to aggravate the damage to the terrain since only three of the four drive wheels may be in contact with the ground.

The ground disturbance problems associated with the use of skid steer vehicles on soft ground, the wear problems associated with their use on hard surfaces and the loss of vehicle traction on uneven terrain tends to limit the use of skid steer vehicles to construction sites and other locations where damage to the ground is permissible and where the terrain is relatively even. Furthermore, the limited reach afforded by the fixed length loader arms has precluded their use where it is difficult or impossible to maneuver the vehicle close enough to the desired work position.

Therefore, there is a need in the art for a compact and highly maneuverable construction vehicle that is operable on uneven terrain, that reduces damage to the ground and wear to the vehicle tires, and that is capable of providing reach for a work implement to achieve the desired work position.

### SUMMARY OF THE INVENTION

The present invention is directed to a compact loader type construction vehicle comprising a chassis having a longitudinal axis, a plurality of wheeled ground-engaging structures pivotally coupled to the chassis, and a steering control system. Each of the plurality of ground-engaging structures comprises a wheel pivotable about a steering axis and drivable about a drive axis, wherein each of the wheeled ground-engaging structures is shaped and configured so that the wheel of each of the ground-engaging structures can be pivoted from a first angular position in which the drive axis is perpendicular to the longitudinal axis, to a second angular position that is at least 90° degrees from the first angular position. The steering control system is operatively connected to each of the ground-engaging structures for pivoting the wheel of each of the wheeled ground-engaging structures about the steering axis.

The steering control system is preferably operable to selectively configure the ground-engaging structures into a plurality of different steering configurations and to steer the chassis in each of the plurality of different steering configurations.

According to one embodiment of the invention, each of the wheeled ground-engaging structures comprises a pivot member pivotally coupled to the chassis for movement about the steering axis, a drive motor having a motor housing rigidly coupled to the pivot member and a drive shaft extending along the drive axis, the drive axis being orthogonal to and pivotable about the steering axis, a hub fixedly coupled to the drive shaft for releasably securing the wheel thereto, and an actuator coupled to the pivot member and to the chassis for pivoting the pivot member about the steering axis.

The invention is also directed to a loader vehicle including a chassis, a plurality of wheeled ground-engaging structures, a loader arm, a telescopic actuator, and an arm actuator. The plurality of wheeled ground-engaging structures are pivotally coupled to the chassis for supporting and steering the loader vehicle. The telescopic loader arm has a first section secured to and pivotable with respect to the chassis and a second section shaped to receive a work implement, the second section being telescopically movable with respect to the first section. The telescopic actuator is configured for moving the second section with respect to the first section, to retract and extend the second section with respect to the first section along a longitudinal arm axis. The arm actuator is configured for pivoting the loader arm with respect to the vehicle.

According to one embodiment of the invention there is provided a compact loader type construction vehicle having a chassis with a front end, a rear end, a right side and a left side. On the right side of the vehicle there is a first pair of wheels, each wheel being driven by one of a first pair of hydraulic wheel drive motors. On the left side of the vehicle there is a second pair of wheels, each wheel being driven by one of a second pair of hydraulic wheel drive motors.

In some embodiments, the vehicle includes a vehicle engine, which can be any suitable engine such as an internal combustion or electric engine. Also attached to the vehicle structure are two hydraulic hydrostatic drive pumps each connected to and driven by the vehicle engine. The first hydraulic hydrostatic pump provides power to propel the first pair hydraulic wheel drive motors to drive the wheels on the right side of the vehicle. The two drive motors on the right side of the vehicle are connected to the hydrostatic pump such that each drive motor will turn each wheel in the same rotational direction when pressure is provided by the corresponding hydrostatic drive pump. Similarly, the second hydraulic hydrostatic pump provides power to propel the second pair of hydraulic wheel drive motors on the left side of the vehicle to drive the wheels on the left side of the vehicle. Similar to the drive motors on the right side, the drive motors on the left side of the vehicle are connected to the second hydraulic hydrostatic pump such that each drive motor will turn each of the second wheels in the same rotational direction when a hydraulic pressure is applied during use.

In some embodiments, the chassis of the vehicle is coupled to and supported by the four wheels via steerable ground-engaging structures coupled to the four hydraulic wheel drive motors. As discussed in further detail below, the front left and rear left hydraulic wheel drive motors are attached to steerable ground-engaging structures located on the left side of the vehicle. Similarly, the front right and rear right hydraulic wheel drive motors are attached to steerable ground-engaging structures located on the right side of the vehicle.

In one embodiment, each steerable ground-engaging structure is coupled to at least one hydraulic actuator that can be used to rotate the steerable ground-engaging structure about a pivot axis to provide a predetermined amount of rotation. In one exemplary embodiment, each steerable ground-engaging portion can be rotated about its pivot axis at least 135 degrees of rotation in total. In another embodiments, each steerable ground-engaging portion can be rotated about its pivot axis at least 90 degrees of rotation. In this manner, the wheels of the vehicle can be configured in a number of different steering configurations to provide the vehicle with the desired level of mobility and steering characteristics when in use at a worksite.

In some embodiments, each steerable ground-engaging structure also generally has at least one electronic feedback sensor, which can be coupled to the hydraulic actuators, and which provides information such as position information about the angular position of the ground-engaging structure.

According to some embodiments, during use, the hydraulic actuators are coupled to each ground engaging-structure and can be controlled by an operator using control devices, such as a joystick, an operator steering mode switch or other input devices. The control devices function in cooperation with an electronic microcontroller containing steering algorithms, which receives feedback from the electronic feedback sensors and controls at least one hydraulic steering control valve to adjust the steering configuration of the vehicle. The electronic microcontroller is used to rotationally position each of the four ground-engaging structures by adjusting each of the four hydraulic actuators according to desired operator input. The four electronic feedback sensors can transmit information about the angular position of each of the four ground-engaging structures back to the electronic microcontroller, providing a feedback control loop.

In some embodiments, the control system can also continually monitor the operator's control inputs, including desired steering position and steering mode, and compare these inputs against the angular rotational position of each ground-engaging structure to ensure each wheel is in the desired steering position. In some embodiments, the control system can also collect information from the sensors to monitor velocity and acceleration of the hydraulic actuators and ground engaging structures to ensure that desired vehicle operating characteristics are being met.

In some embodiments, the ground-engaging structures located on the front right and front left of the vehicle are coupled to the vehicle chassis in a rigid manner without any shocks or suspension system. This rigid configuration tends to provide improved stability of the vehicle when the vehicle is subjected to uneven loads. In other embodiments, the ground engaging structures can be coupled to the vehicle chassis by a suspension system, which may include a passive or active spring-damper suspension apparatus, which may provide the operator with a smoother ride and finer control over the vehicle operation, particularly when in use on uneven terrain.

In some embodiments, the distance between the steering pivot points (e.g. the axis about which each of the ground-engaging structures pivots) on the front right and front left ground-engaging structures has been maximized within the limits of the vehicle size in order to further enhance vehicle stability.

In some embodiments, the ground-engaging structures located on the rear of the vehicle are mounted to and pivotable about a single rear assembly comprising a rear transverse frame member that defines a transverse axis. The rear assembly is then pivotally mounted on the vehicle chassis about a single pivot point such that the entire rear assembly can pivot with respect to the vehicle chassis. The single pivot point is preferably located rearwardly of the vehicle and proximate the middle of the vehicle chassis. The corresponding pivot point on the rear assembly is generally located in the middle of the rear assembly.

According to some embodiments, during use, the rear assembly can pivot with respect to the vehicle pivot point when the vehicle is traveling over uneven terrain, which helps to keep the wheels on the rear of the vehicle in constant contact with the ground. This tends to provide improved traction and stability when compared to prior art skid steer loaders because all four wheels on the vehicle tend to stay in contact with the terrain, even when the vehicle travels over uneven terrain. During operation of the skid steer vehicle, the speed and direction of the hydraulic wheel drive motors on the left side of the vehicle and on the right side of the vehicle are independent, but can preferably be easily controlled by the operator using the control devices, including the joystick and an operator steering mode switch. The inputs from the operator are provided to the electronic microcontroller, which contains a propulsion algorithm and controls the hydraulic hydrostatic pumps accordingly.

In some embodiments, the electronic microcontroller will provide the operator with the ability to select a variety of different steering modes or configurations. Within each distinct steering mode, the operator will have the ability to manipulate the pivotal position of each of the wheels within a predetermined pivotal range through the use of the control devices, including the joystick.

In some embodiments, the range of movement of the ground-engaging structures will be determined by the direction and angle of movement of the electronic joystick and the steering mode selected by the operator. The electronic joystick will also allow the vehicle operator to proportionally change the rotation drive speed and direction of rotation of each hydraulic wheel drive motor, within a predetermined range set by the electronic microcontroller, in order to obtained the desired maneuvering characteristics.

In some embodiments, the vehicle also includes a loading arm that includes two relative telescoping sections. The first section of the loading arm is mounted pivotally on the chassis using a pivot mount, and configured for pivotal rotation in a vertical direction with respect to the ground surface. The pivot mount is generally located towards the rear of the vehicle chassis, preferably above the rear wheels.

In some embodiments, the first section of loading arm includes a curved portion permitting the telescopic loading arm to reach below the ground contact surface of wheels for use in digging or other operations.

In some embodiments, the second section of loading arm is coupled to the first section and is generally movable with respect to the first section. In some embodiments, the second section fits over the first section such that the first and second section can telescope relative to each other. The telescopic movement is effected by a hydraulic cylinder or other telescopic actuator which can be located internally of the telescopic boom arm assembly. In such embodiments, the second portion can be extended or retracted according to inputs from the operator.

In other embodiments, the second section can be coupled to the first section in any number of other suitable manners. For example, the second portion could be pivotally coupled to the first section such that it is pivotable with respect to the first section in one or more of a horizontal or vertical direction. At the distal end of loading arm (furthermost from the chassis) is a support structure that is mounted on the second section of the loading arm. In some embodiments, the support structure is pivotally coupled to the second section of the loading arm, while in other embodiments the support structure is rigidly coupled to the second section. The support structure preferably includes a tool supporting structure allowing for the connection of work implements, such as loader buckets, pallet forks, excavator buckets and other implements, to the loading arm.

Further aspects and advantages of the embodiments described herein will appear from the following description taken together with the accompanying drawings.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a perspective view from the front and right side of a vehicle made in accordance with an embodiment of the invention;

FIG. 2 is a perspective view of the vehicle of FIG. 1 showing the chassis with the wheels and body removed;

FIG. 2A is a close-up perspective view of a front ground engaging structure on the vehicle of FIG. 1;

FIG. 3 is a perspective view of the vehicle of FIG. 1 showing the chassis with wheels mounted thereon for movement in a forward and reverse direction;

FIG. 4 is a perspective view of a rear transverse frame member and rear ground-engaging structure of the invention;

FIG. 4A is a close-up perspective view of a portion of the right-rear ground-engaging structure of FIG. 4;

FIG. 5 is a perspective view of the vehicle of FIG. 1 showing the vehicle in a rear wheel steering condition;

FIG. 6 is a perspective view of the vehicle of FIG. 1 showing the vehicle in a front wheel steering condition;

FIG. 7 is a perspective view of the vehicle of FIG. 1 showing the vehicle in an all-wheel steering condition;

FIG. 8 is a perspective view of the vehicle of FIG. 1 showing the vehicle in a crab steering condition;

FIG. 9 is a perspective view of the vehicle of FIG. 1 showing the vehicle in a counter rotating steering condition;

FIG. 10 is a perspective view of the vehicle of FIG. 1 showing the vehicle in a side steering condition;

FIG. 11 is a perspective view of the vehicle of FIG. 1 showing the vehicle in a second all-wheel steering condition;

FIG. 12 is schematic illustrating steering and propulsion control systems for use with the vehicle of FIG. 1 in accordance with one embodiment; and

FIG. 13 is a side elevation view of the vehicle of FIG. 1 showing the loader arm in an extended and a retracted position.

### DETAILED DESCRIPTION OF THE INVENTION

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

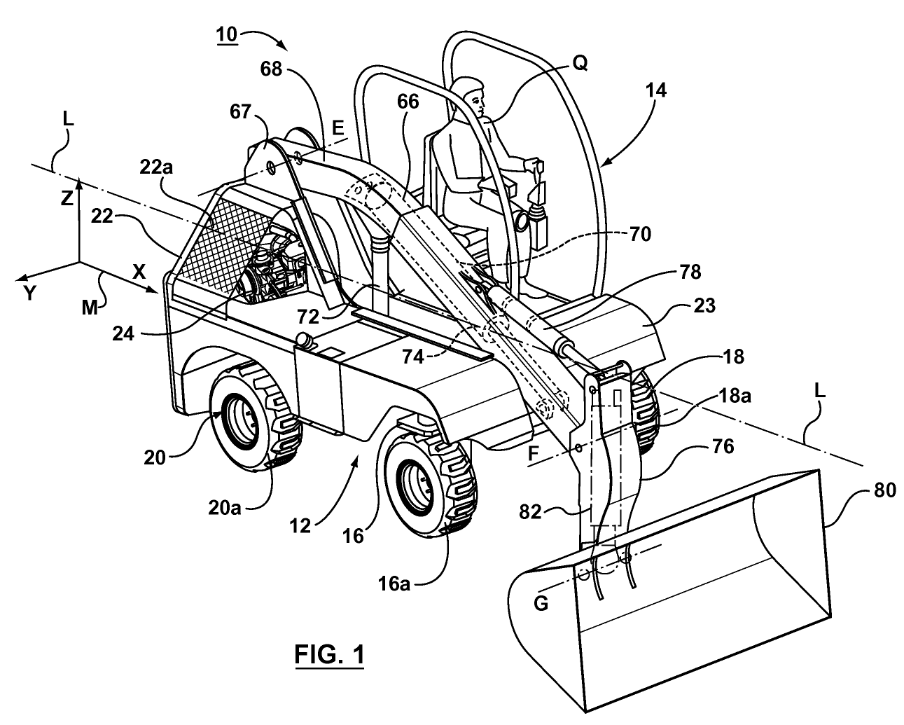

Referring now to FIGS. 1 to 4A generally, illustrated therein is compact loading vehicle 10 made in accordance with one embodiment of the present invention. For ease of reference, there are also shown axes M which are not part of the vehicle 10 but which simply serve as a tool for more clearly describing the structure and operation of the vehicle 10. The axes M include an x-axis, a y-axis and a z-axis, indicated in the positive direction by the direction of the arrows as shown. For consistency, the term “forward” as used herein generally refers to the direction of the positive x-axis of axes M, while the terms “rear”, “reverse” and “rearward” generally refers to the direction of the negative x-axis of axes M. Similarly, the term “right side” generally refers to the direction of the positive y-axis of axes M, while the term “left side” generally refers to the direction the negative y-axis of the axes M.

Vehicle 10 generally includes a chassis 12 on which there is provided an operator's compartment 14 in which an operator Q is shown seated. The compartment 14 is positioned forwardly and to left side of the chassis 12 from the perspective of the operator Q as seated in the compartment 14. The chassis 12 is supported by a front right wheeled ground-engaging structure 16, a front left wheeled ground-engaging structure 18 and rear wheeled ground-engaging structures 20 (including pivoting members 54, 56), as will be described in greater detail below. To the rear of the operator's compartment 14 and extending across the vehicle chassis 12 is a bonnet structure 22 which houses a vehicle engine 24 for powering the vehicle 10. The bonnet structure 22 is connected to a cowling 22a, which can be a metallic mesh structure or other suitable cover, and is configured to prevent unauthorized access to the vehicle engine 24 and to protect the operator Q and others from the moving parts of the engine 24 when the vehicle 10 is in use.

The vehicle 10 also generally includes a body 23 designed to protect the operator Q from exposure to flying debris during use by acting as a shield between the operator Q and the chassis 12. The body 23 can be one continuous piece or alternatively can include a number of different panel members, and the body 23 can be made of any suitable material such as a metal or strong plastic.

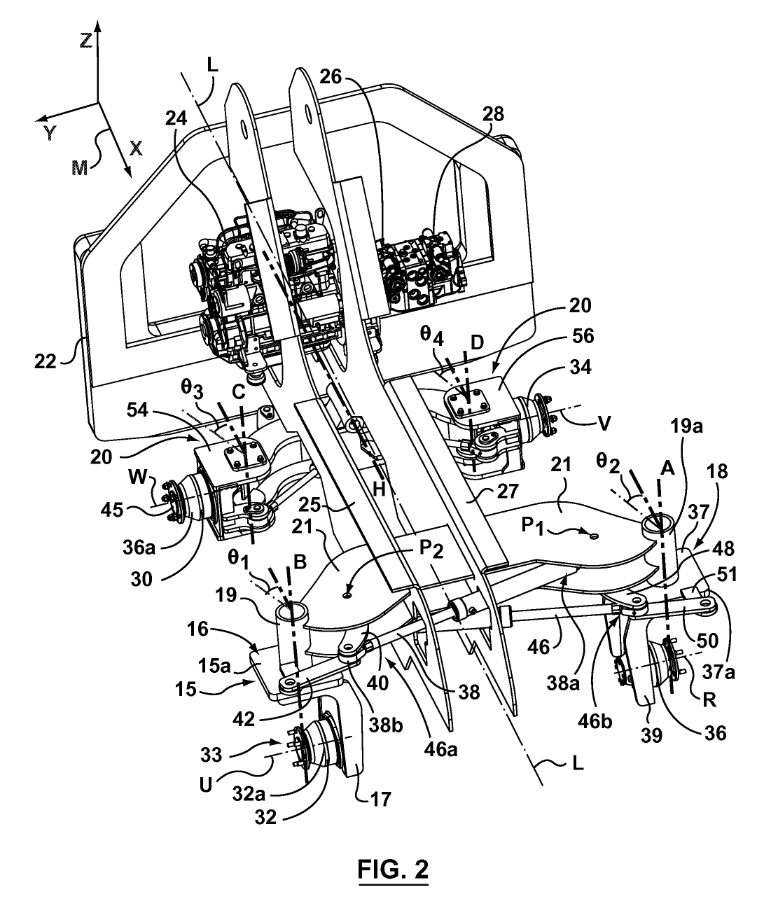

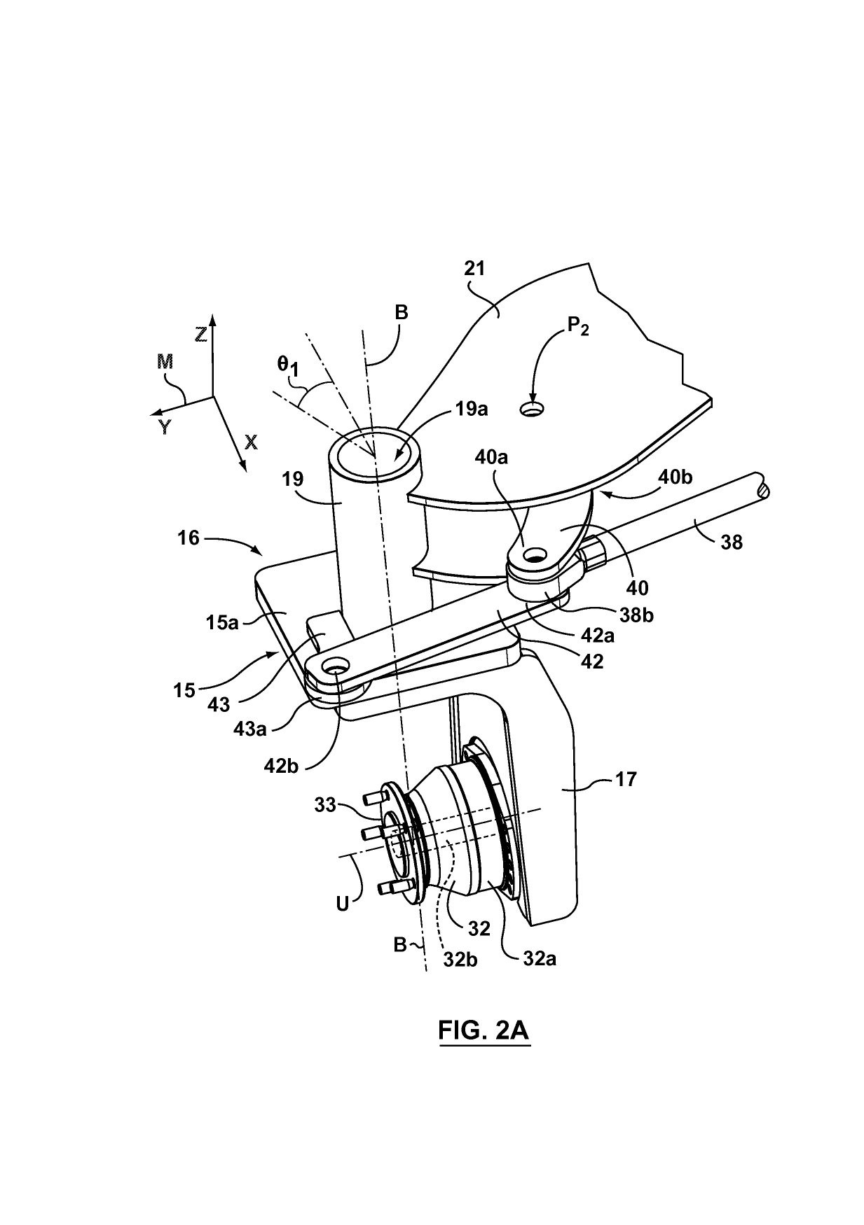

Referring now specifically to FIG. 2, there is provided first and second hydrostatic hydraulic pumps 26 and 28 connected to, and driven by, the vehicle engine 24. Also shown in FIG. 2 are right-side hydraulic wheel drive motors 30, 32 which are in fluid communication with the first hydrostatic hydraulic pump 26 and left-side hydraulic wheel drives 34, 36 which are in fluid communication with the second hydrostatic hydraulic pump 28.

During use, the first hydrostatic pump 26 provides hydraulic power for the right-side drive motors 30 and 32 that are located on the right side of the vehicle 10. Hydrostatic pump 26 has the ability to provide oil flow in two directions such that hydraulic wheel drive motors 30 and 32 can be rotated in either a clockwise direction or a counterclockwise direction based on the desired direction of vehicle travel. In some embodiments, both hydraulic wheel drive motors 30 and 32 will rotate in the same clockwise or counterclockwise direction during use.

Similarly, the second hydrostatic pump 28 provides hydraulic power for the left-side hydraulic wheel drive motors 34 and 36 located on the left side of the vehicle. Hydrostatic pump 28 has the ability to provide oil flow such that the left-side drive motors 34 and 36 rotate in either a clockwise direction or counterclockwise direction, according to the desired direction of vehicle travel. In one embodiment, both hydraulic wheel drive motors 34 and 36 will rotate in the same clockwise or counterclockwise direction during use.

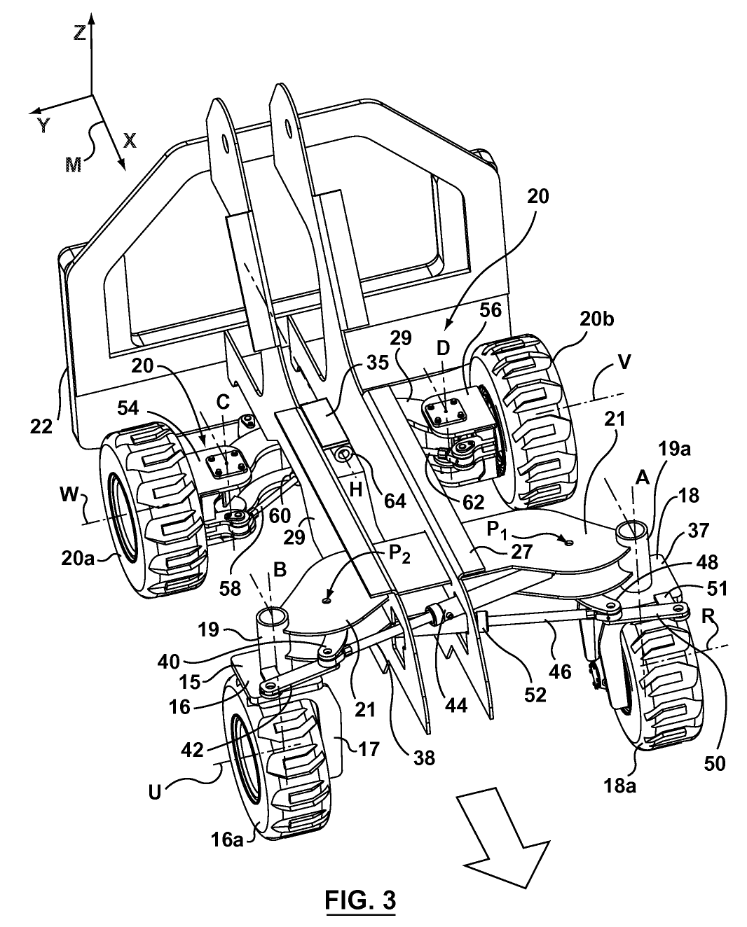

Referring now to FIG. 2A, the front right wheeled ground-engaging structure 16 is shown in greater detail and generally includes pivot member 15 having an inverted L-shape as defined by an upper arm portion 15a being generally horizontal and a lower arm portion 17 being generally vertical and extending downwards from the upper arm portion 15a. The lower arm portion 17 is coupled to and supports the drive motor 32. The drive motor 32 includes motor housing 32a rigidly coupled to lower arm portion 17, and a drive shaft 32b extending along a drive axis U, which is orthogonal to steering axis B. Hub portion 33 is fixedly coupled to the drive shaft 32b. Wheel 16a is releasably secured to the hub portion 33 during use, as shown for example in FIG. 3.

The upper arm portion 15a is coupled to and rotatable with respect to a fixed tubular member 19, which is generally cylindrical in shape and has an opening 19a for receiving a shaft affixed to the upper arm portion 15a. Tubular member 19 is rigidly coupled to a front transverse frame member 21, preferably by welding. As best shown in FIG. 2, the front transverse frame member 21 connects the front right ground-engaging structure 16 to the front left ground-engaging structure 18 and to longitudinal frame members 25 and 27 that run along the longitudinal axis L of the chassis 12.

During use, the front right ground-engaging portion 16 is steered by the operation of a hydraulic actuator 38, the first end 38a of the actuator 38 being coupled to the front transverse frame member 21 at point P₁. The other end 38b of the hydraulic actuator 38 is coupled to a first end 40a of a first link member 40 (or first steering structure member). The first link member 40 is pivotally connected at a second end 40b to the front transverse frame member 21 at point P₂. The first link member 40 and hydraulic actuator 38 are also pivotally coupled to a first end 42a of a second link member 42 (or second steering structure member). In turn, the second link member 42 is pivotally coupled at a second end 42b to a first end 43a third link member 43, the other end of which is rigidly secured to the upper arm portion 15a of the front right ground-engaging portion 16. The third link member 43 can be rigidly coupled to the upper arm portion 15a in any suitable fashion, such as by welding or bolting. As described in more detail below, as the hydraulic actuator 38 retracts and extends, it causes the front right ground-engaging structure 16 to rotate about a steering axis B, which is an axis that is generally vertical with respect to the ground surface. The pivoting of ground-engaging structure 16 results in drive axis V pivoting about steering axis B.

Similar to the right side wheeled ground-engaging structure 16, and as shown in FIG. 2, the left-side wheeled ground-engaging structure 18 includes pivot member 37 mounted to the front left side of the front transverse member 21 of the vehicle chassis. Pivot member 37 has an inverted L-shape, and includes an upper arm portion 37a that is generally horizontal and a lower arm portion 39 which extends vertically downwards from the upper arm portion 37a and carries the drive motor 36 having a drive shaft extending along drive axis R, which is orthogonal to and pivotable about steering axis A. The upper arm portion 37a is pivotably coupled to fixed tubular member 19a, which is rigidly coupled to the front transverse frame member 21.

The left-side ground-engaging structure 18 is pivotable about steering axis A, which is an axis generally vertical with respect to the ground surface. Pivoting of the ground-engaging structure 18 is effected by hydraulic actuator 46, which is coupled at a first end 46a to the front transverse frame member 21 at point P₂, and at a second end 46b to a first link 48 (as shown in FIG. 2). The first link 48 is also pivotally coupled to the front transverse frame member 21, and is connected to the hydraulic actuator 46 and a second link 50. Second link 50 is pivotally connected to a third link member 51, which is rigidly coupled to the upper arm portion 37a of the ground-engaging structure 18.

The lateral distance along the front transverse member 21 between the steering axis B for ground-engaging structure 16 and the steering axis A for ground-engaging structure 18 is preferably maximized within the limits of the vehicle structure to enhance lateral vehicle stability when lifting uneven loads or when the vehicle 10 is traveling over uneven terrain.

Referring now specifically to FIG. 3, the chassis 12 of the vehicle 10 is shown with the body 23 removed but with the wheels 16a, 18a, 20a, 20b attached in a forward steering configuration with the wheels 16a, 18a, 20a, 20b being pivot to rotate in a forward and rearward direction (generally parallel to the x-axis and running along the longitudinal axis of the chassis 12). FIG. 3 clearly shows that the steering axes A and B lie substantially within the wheels 16a, 18a, which is provided by the upper arm portions 15a, 37a overhanging the wheels 16a, 18a respectively. By placing the pivot axis in line with the front wheels 16a, 18a, with the upper arm portions 15a, 37a overhanging, the front wheels 16a, 18a can be pivoted to significant degrees of angular rotation without interfering with the front transverse member 21.

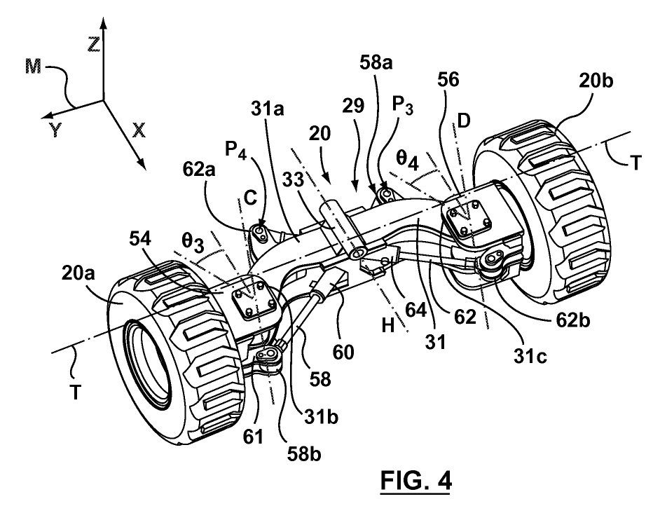

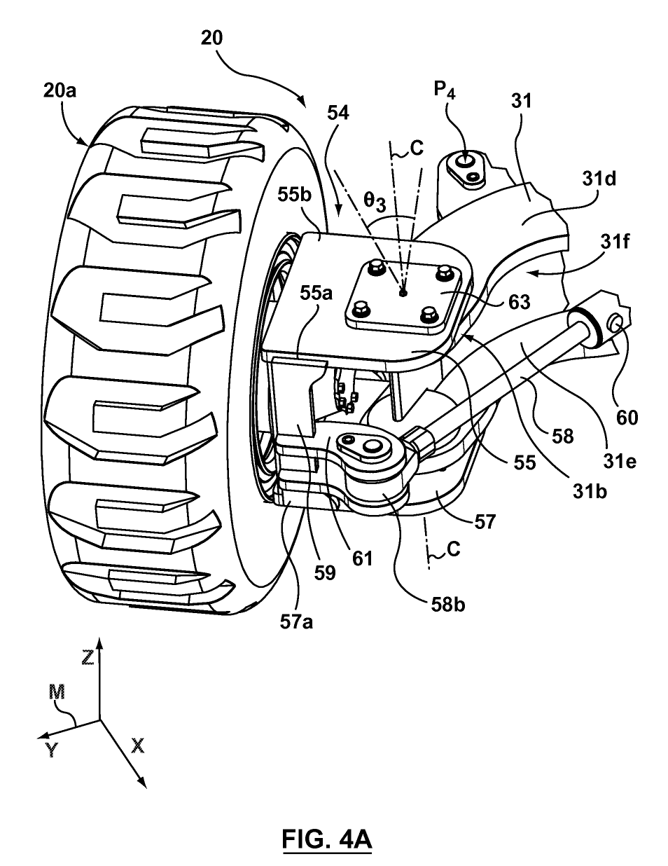

Turning now to FIGS. 4 and 4A, the rear wheeled ground-engaging structures 20 of the vehicle 10 shown in greater detail. The ground-engaging structures 20 comprise pivot members 54 and 56, which are pivotally coupled to a rear transverse frame member 29, the pivot members 54, 56 supporting two rear wheels 20a and 20b.

The rear transverse frame member 29 is pivotally coupled to frame member 35 by member pivot mount 33 and pivot mount 41 positioned beneath a frame member 35 on the chassis 12 (as shown in FIG. 3). The rear transverse frame member 29 generally includes a first straight portion 31a that defines a rear transverse axis T (as shown in FIG. 4), a right curved end 31b, and a left curved end 31c. The curved ends 31b, 31c allow the steering or pivoting axes C, D of the rear wheels 20a, 20b to be longitudinally offset from the transverse axis T and straight portion 31 a such that the wheels 20a, 20b will not interfere with the rear transverse frame member 29 during pivoting.

As shown in FIG. 4A, the rear transverse frame member 29 has a generally I-shaped cross section, with an upper plate 31d and a lower plate 31e separated by a web member 31f.

The interoperability between the pivot mounts 33 and 41 allows the rear transverse frame member 29 to be pivotally mounted to the vehicle chassis 12 such that the rear frame member 29 can pivot about rotational axis H (as shown in FIG. 4) with respect to the vehicle chassis 12 in response to changes in ground elevation during operation of the vehicle 10. The pivoting tends to keep the rear wheels 20a, 20b in better contact with the ground surface, particularly on uneven terrain.

The corresponding pivot point 41 on the frame member 35 of the chassis 12 is generally located to the center and the rear of the vehicle chassis 12.

As best shown in FIG. 4A, the pivot member 54 generally has a C-shaped profile as defined by an upper plate member 55 and a lower plate member 57 that is generally parallel and spaced apart from the upper plate member 55. The lower plate member 57 and the upper plate member 55 are joined by a connecting plate member 59 that is perpendicular and is secured at ends 55a, 57a of the upper plate 55 and lower plate 57 proximate the wheel 20a. Although not shown in the figures, a corresponding connecting plate member is also provided towards a rear end 55b of the upper plate 55 and a rear end (not visible) of the lower plate 57.

As best shown in FIG. 2, the drive motor 30 on the rear pivot member 54 includes a motor housing 36a rigidly coupled to the pivot assembly 54, and a drive shaft (not shown) extending along drive axis W, which is orthogonal to steering axis C. Hub portion 45 is fixedly coupled to the drive shaft for releasably securing the wheel 20a to the drive motor 30. Steering axis C is generally vertical with respect to the ground surface, and passes through a lower plate member 57 of the pivot member 54.

During use, wheel 20a and pivot member 54 can be pivoted about steering axis C by movement of hydraulic actuator 58, which is coupled at a first end 58a to the rear transverse frame member 29 at point P₃ (as shown in FIG. 4). The other end 58b of the hydraulic actuator 58 is coupled to a link member 61 that is rigidly coupled to the connecting plate member 59. As the hydraulic actuator 58 retracts and expands, it causes a corresponding movement in the pivot member 54 about the steering axis C, which results in drive axis W pivoting about steering axis C. The angular position of the pivot member 54 and wheel 20a can be measured by an electronic feedback sensor 60, which can be located at any suitable location such as internally of hydraulic actuator 58.

Similar to the right side, pivot member 56 generally has a C-shaped profile. The wheel 20b and pivot member 56 of the left side can be pivoted with respect to the rear transverse frame member 31 by hydraulic actuator 62, which results in drive axis V pivoting about steering axis D. Hydraulic actuator 62 is pivotally coupled at a first end 62a to the transverse frame member at point P₄ and at a second end 62b to a second link arm 63, which is rigidly coupled to the left side pivot member 56. The angular position of pivot member 56 and wheel 20b can be measured by an electronic feedback sensor 64, which can be located at any suitable location such as internally of hydraulic actuator 62.

As best shown in FIG. 4, hydraulic actuators 58 and 62 are mounted within the rear transverse frame member 29 in a generally crossed configuration to make the rear transverse frame member 29 fairly compact.

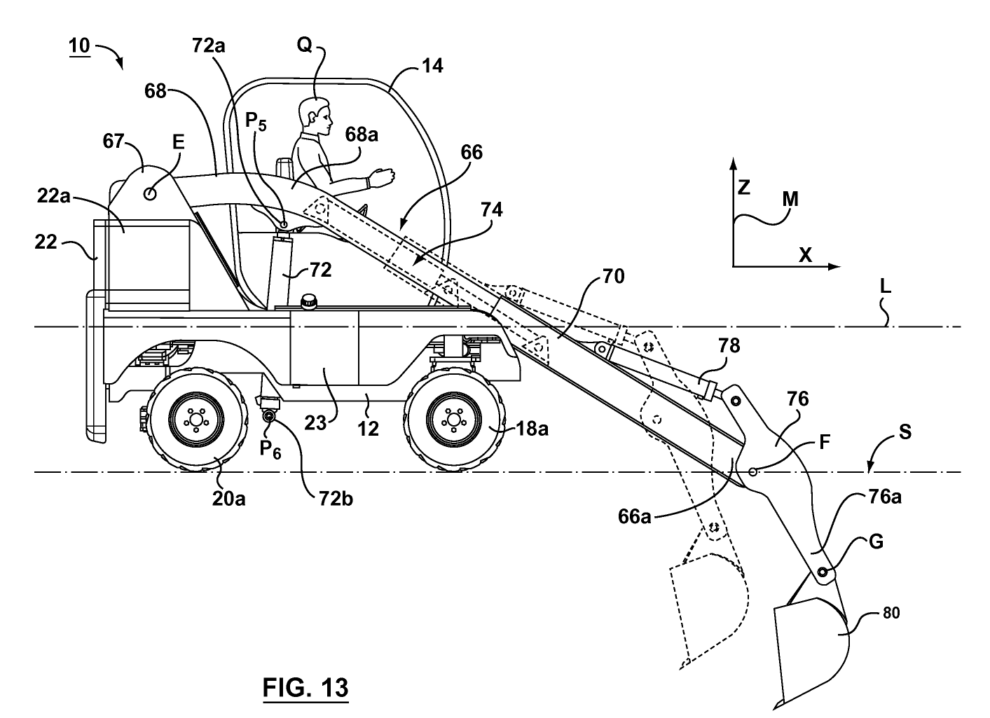

Referring now to FIGS. 1 and 13, vehicle 10 may comprise a loading arm 66 that includes two sections, a first section 68 and a second section 70. In some embodiments, the first section 68 and the second section 70 are telescopic with respect to each other, such as by having the second section 70 be slightly larger that the first section 68 and configured to fit over the first section 68. The loading arm 66 extends longitudinal along the longitudinal axis L of the vehicle 10, generally parallel to the longitudinal frame member 25 and 27 towards the front of the vehicle, running alongside the operator's compartment 14.

In some embodiments, the first section 68 and second section 70 each have hollow interiors. The hollow interior of the second section 70 is shaped to receive the straight portion of the first section 68.

In some embodiments, the second section 70 of the loading arm 66 fits over the first section 68 and can be moved telescopically along the longitudinal axis of the arm 66 (extending and retracting) by one or more telescopic actuators 74 located within the hollow interior of the arm 66. Actuators 74 can be any suitable type actuator, such as a hydraulic or electric actuator.

The first section 68 of loading arm 66 is mounted pivotally on the vehicle chassis 12 at a pivot mount 67 for vertical pivoting movement with respect to the ground surface about a generally horizontal axis E, as effected by one or more actuators 72. Pivot mount 67 is generally located towards the rear of the vehicle 10 and is preferably mounted above and slightly to the rear of the rear wheels 20a and 20b. Actuator 72 is pivotally connected at a first end 72 to the first section 68 a point P₅ and at a second end 72b to the chassis 12 at point P₆, as best shown in FIG. 13.

In some embodiments, the first section 68 of loading arm 66 includes a curved portion 68a as best shown in FIG. 13 that permits the telescopic loading arm 66 to be angled generally downwards to reach below the ground contact surface S of wheels 16a and 18a.

At a distal end 66a of loading arm 66 (furthermost from the vehicle chassis 12) there is provided a support structure 76 that is pivotally mounted to loading arm 66 about a generally horizontal axis F for vertical movement of the structure 76 effected by one or more actuators 78.

At a distal end 76a of support structure 76 (furthermost from axis of rotation F) there is provided a work implement 80 such as an excavating bucket or loading bucket, which can be releasably connected to the support structure and which is pivotal about axis of rotation G for vertical movement of the work implement 80 by actuator 82.

In some embodiments, elements of the loading arm 66 such as the first section 68, the second section 70, the support structure 76 and the work implement 80 can be pivotable about an axis of rotation for horizontal movement with respect to the ground surface S to provide improved mobility of the excavating tool 80.

Referring now to FIGS. 2 and 5 to 11 generally, the chassis 12 of the vehicle 10 is shown in various different steering configurations. As discussed above, to achieve the different steering configurations, the wheels 16a, 18a, 20a, 20b are generally pivotable about the steering axes B, A, C, D respectively. This allows the wheels 16a, 18a, 20a, 20b to be oriented in various different directions to achieve the desired steering configurations and provide a desired level of mobility to the vehicle 10 during use.

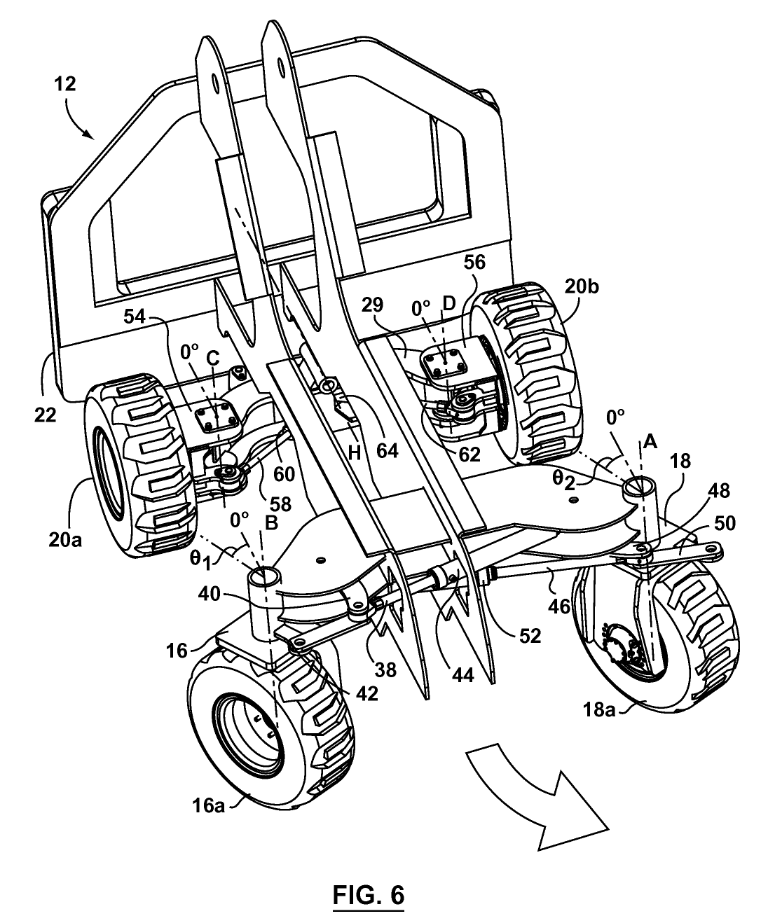

For example, as shown in FIG. 6 the front right ground-engaging structure 16 can be rotated pivotally about the vertical axis B. The rotation can be measured by angle 01, defined as the angle swept by the ground-engaging structure 16 as it rotates from an origin located at axis B running in the negative x-direction, looking down at the vehicle 10 from above. For consistency, θ₁ is defined as being positive in the counter-clockwise direction and negative in the clockwise direction.

According to some embodiments, the front right ground-engaging structure 16 can be pivoted by the hydraulic actuator 38 clockwise such that θ₁ can reach −30 degrees, and counterclockwise such that θ₁ can reach +105 degrees. The ability to pivot to this extent is provided by the specific shape and configuration of the ground-engaging structure 16, which allows the wheel 16a to pivot without interference from any structural members.

The angle θ₁ of rotation of the ground-engaging structure 16 can be measured by an electronic feedback sensor 44, which can be located internally of hydraulic actuator 38 or at any other suitable location.

Similarly, and again as shown in FIG. 6, the left front ground-engaging structure 18 can be rotated pivotally about axis A, and measured by angle θ₂ with reference to a second origin located at the axis A and being parallel to the first origin. For consistency, θ₂ is defined as being positive in the counter-clockwise direction and negative in the clockwise direction.

The left side ground-engaging structure 18 can be pivoted counterclockwise such that θ₂ can reach +30 degrees and clockwise such that θ₂ can reach −105 degrees. The angle θ₂ of rotation of the ground engaging structure 18 can be measure by electronic feedback sensor 52 which can be located internally of hydraulic actuator 46 or at any other suitable location.

In this manner both the front wheels 16a, 18a can be independently pivoted by a significant amount (up to 135 degrees total) to provide the various steering configurations as described in detail below. As shown in FIG. 6, the wheels 16a, 18a have been pivoted in the same direction such that θ₁ and θ₂ are about 30 degrees in the counter-clockwise direction.

In some embodiments, as described above, the ground-engaging structure 16, 18 are pivotable in an asymmetric manner such that they can pivot in one angular direction more than they can pivot in the other direction. It will be appreciated that the amount of angular rotation that is possible and the asymmetry achieved is generally dictated by the geometry of the linkages 40, 42, 43, 48, 50, 51 cooperating with the actuators 38, 46. As described below, as the steering control system is able to independently control the pivoting and rotation of each wheel 16a, 18a, it is generally not required that the wheels 16a, 18a be pivotable in a symmetric fashion. What is generally desirable is that the wheels 16a, 18a be pivotable in at least one direction up to at least 90 degrees. This will allow the wheels 16a, 18a to be configured in a side steering configuration, as well as other steering configurations, and provide the desired vehicle 10 mobility.

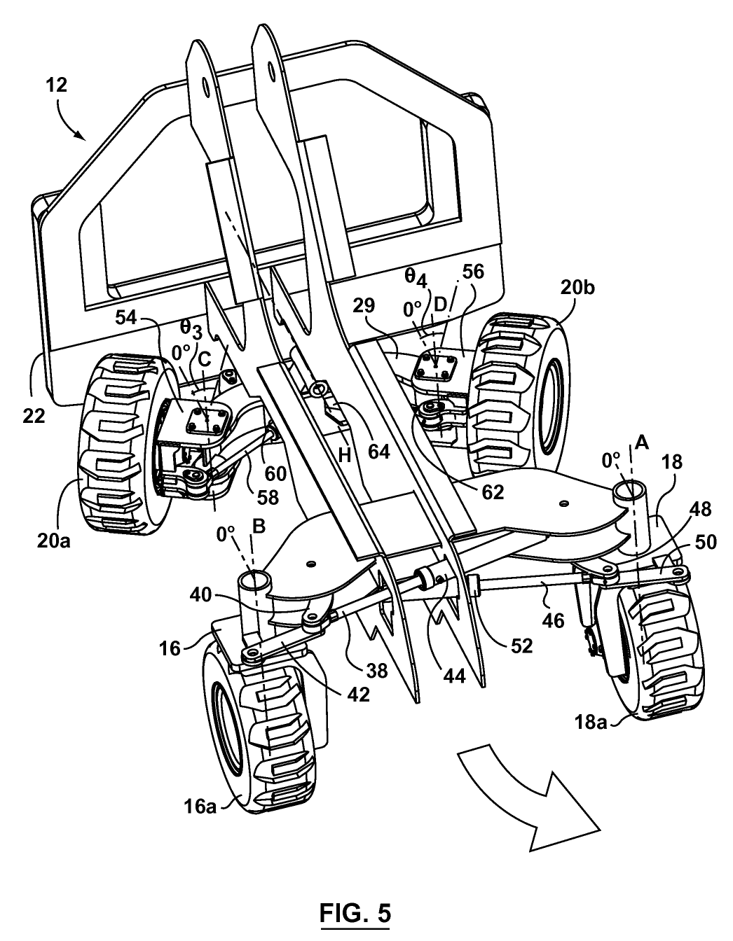

In some embodiments, the rear wheels 20a, 20b of the vehicle 10 are similarly pivotable. For example, and as shown in FIGS. 2 and 5, the right side rear pivot member 54 can generally be rotated by angle θ₃ as measured from a third origin located at steering axis C and running in the negative x-direction. For consistency, θ₃ is defined as being positive in the counter-clockwise direction and negative in the clockwise direction. The rear pivot member 54 can be pivoted clockwise such θ₃ can reach −50 degrees, and counterclockwise such that θ₃ can reach +105 degrees about steering axis C.

Similarly, as shown in FIG. 5, left side rear pivot member 56 can generally be rotated by angle θ₄ as measured from a fourth origin located at steering axis D and running in the negative x-direction. For consistency, θ₄ is defined as being positive in the counter-clockwise direction and negative in the clockwise direction. Rear pivot member 56 can be pivoted counter-clockwise such that θ₄ can reach +50 degrees, and clockwise such that θ₄ can reach −105 degrees about axis D.

In this manner, the wheels 16a, 18a, 20a, 20b can be pivoted about their respective steering axes B, A, C, D to provide the vehicle 10 with many different possible steering configurations. For example, the wheels 16a, 18a, 20a, 20b can be pivoted to provide the vehicle with the following exemplary steering configurations:

(1) Rear Wheel Steering, as shown in FIG. 5. Rear wheel steering can be provided by pivoting both rear pivot members 54, 56 such that θ₃ and θ₄ can be up to ±30 degrees in the same direction (either the clockwise direction, as shown in FIG. 5, or the counterclockwise direction. This configuration of the rear wheels 20a, 20b provides rear wheel steering for the vehicle 10, while the front wheels 16a, 18a are kept parallel to the longitudinal axis L of the vehicle 10 (such that the drive axes of the wheels 16a, 18a are perpendicular to the longitudinal axis L), allowing the vehicle 10 to turn in either a clockwise or counter-clockwise direction while moving the vehicle 10 in either a forward or reverse direction.

(2) Front Wheel Steering, as shown in FIG. 6. Front wheel steering can be provided by pivoting both front ground engaging structures 16, 18 such that θ₁ and θ₂ can be up to ±30 degrees in the same direction (either the counter-clockwise direction, as shown in FIG. 6, or the clockwise direction). This allows wheels 16a, 18a to provide front wheel steering, while the rear wheels 20a, 20b are kept parallel to the longitudinal axis L of the vehicle 10 (such that the drive axes of the wheels 20a, 20b are perpendicular to the longitudinal axis L), allowing the vehicle 10 to turn in either the clockwise or counter-clockwise directions generally when the vehicle 10 is moving in either the forward or reverse directions.

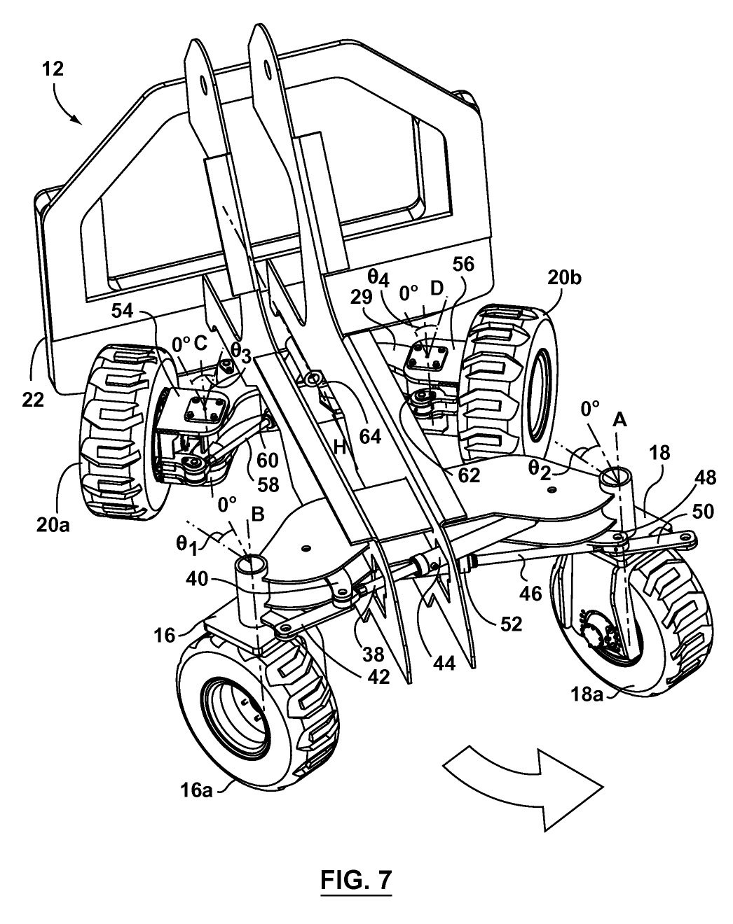

(3) All Wheel Steering, as shown in FIG. 7. All wheel steering can be provided by pivoting both rear pivot members 54, 56 such that θ₃ and θ₄ are up to ±30 degrees in the same direction (either the clockwise direction, as shown in FIG. 7, or the counterclockwise direction), while simultaneously pivoting both front ground engaging assemblies 16, 18 such that θ₁ and θ₂ are up to ±30 degrees in a direction which is opposite the angular direction of the rear pivot members 54, 56 (either in the counter-clockwise direction, as shown in FIG. 7, or the clockwise direction.

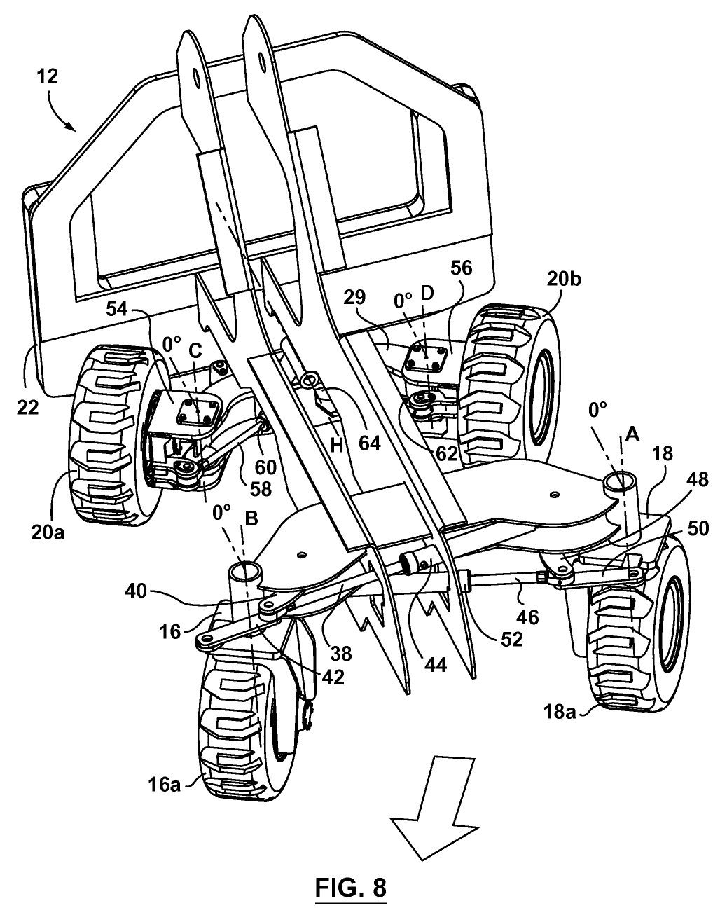

(4) Crab Steering, as shown in FIG. 8. Crab steering can be provided by pivoting both rear pivot members 54, 56 such that θ₃ and θ₄ are up to ±30 degrees in same direction (either the clockwise direction, as shown in FIG. 8, or the counterclockwise direction), while simultaneously rotating both front ground engaging structures 16, 18 such that θ₁ and θ₂ are up to ±30 degrees in the same angular direction as the rear pivot members 54, 56 (either in the clockwise direction, as shown in FIG. 8, or the counter-clockwise direction). As shown in FIG. 8, this configuration provides “crab” steering somewhat to the right when the vehicle 10 is moving in the forward direction, and to the left when the vehicle 10 is moving in the reverse direction.

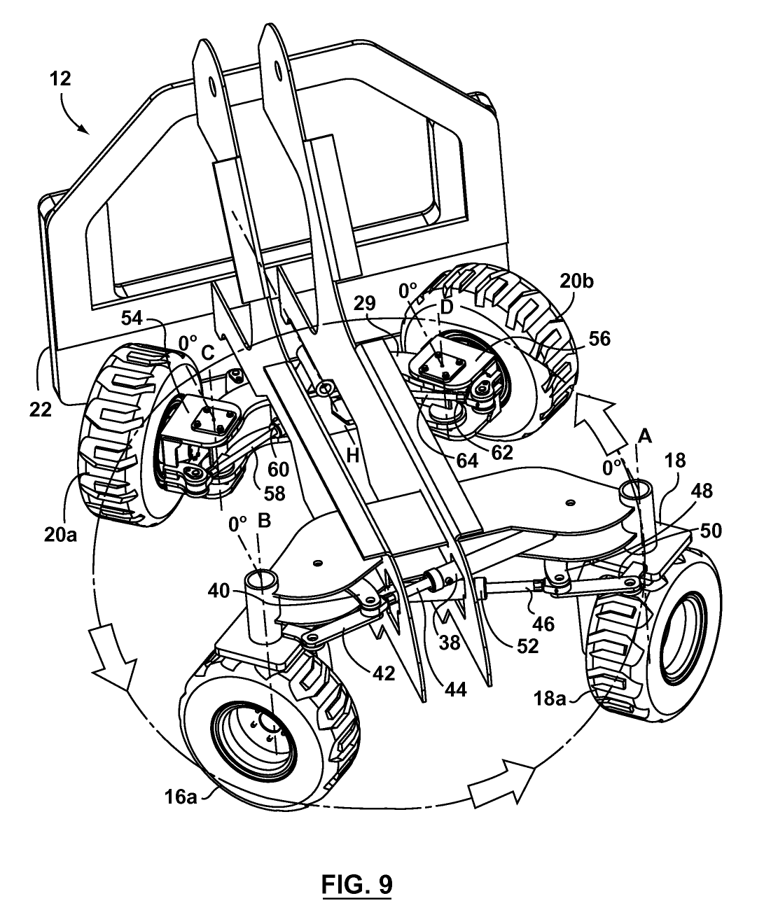

(5) Zero Turning Radius Steering, as shown in FIG. 9. Zero turning radius steering can be achieved by rotating the front right ground-engaging structure 16 and rear left pivot member 56 counter clockwise such that θ₁ and θ₄ are approximately +45 degrees, and rotating the front left ground engaging structure 18 and rear right pivot assembly 54 clockwise such that θ₂ and θ₃ are approximately −45 degrees. This steering configuration allows the vehicle 10 to counter-rotate about the approximate center point of the chassis 12 in either the clockwise or counter-clockwise directions, as shown in FIG. 9.

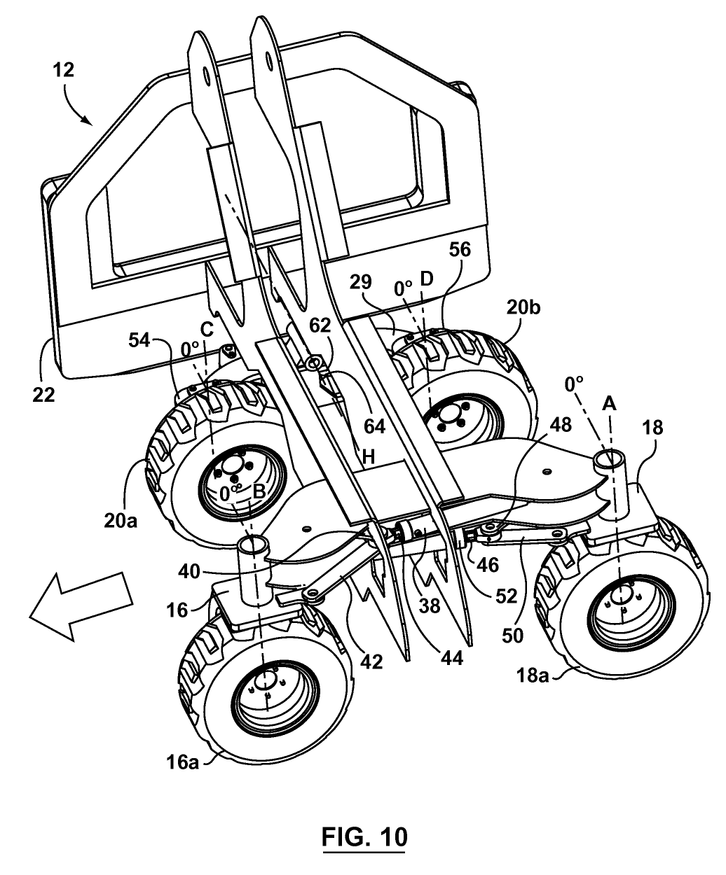

(6) Side Steering, as shown in FIG. 10. The vehicle can be caused to side steer by rotating the front right ground engaging structure 16 and rear right pivot member 54 counter-clockwise such that θ₁ and θ₃ are substantially +90 degrees (such that the drive axes of the wheels 16a, 20a is parallel to the longitudinal axis L), and rotating the front left ground engaging structure 18 and rear left pivot member 56 clockwise such that θ₂ and θ₄ are substantially −90 degrees (such that the drive axes of the wheels 18a, 20b is also parallel to the longitudinal axis L). This steering configuration will align the wheels 16a, 18a, 20a, 20b in generally the same direction perpendicular to the normal alignment shown for example in FIG. 3. This steering configuration allows the vehicle 10 to drive in a straight-line direction towards the left or right side of the vehicle 10, as shown in FIG. 10.

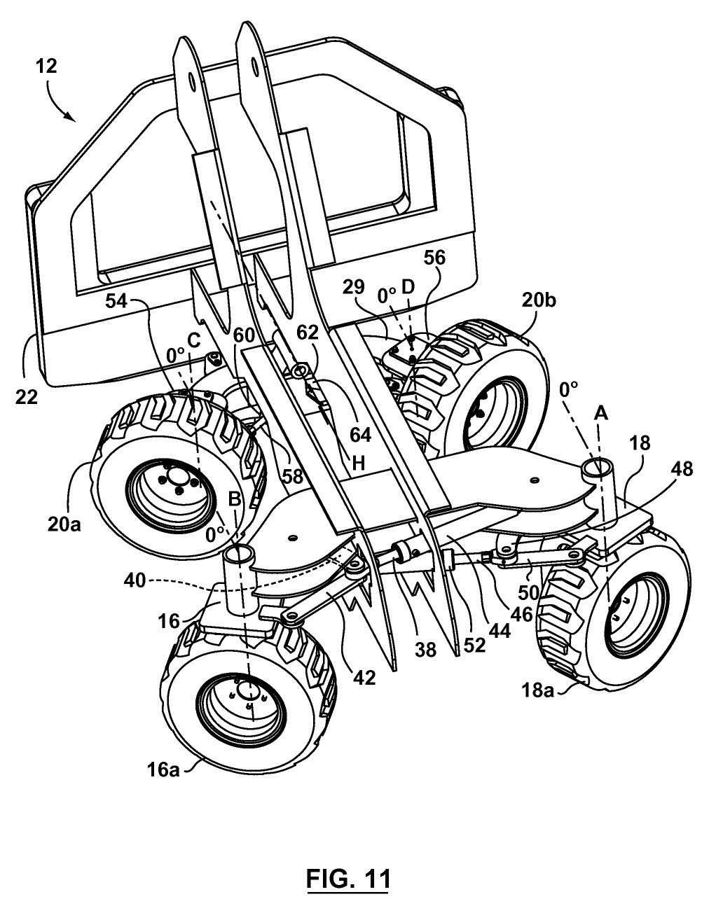

(7) All Wheel Side Steering, as shown in FIG. 11. Similar to the all wheel steering shown in FIG. 7, all wheel side steering can be provided by rotating the front right ground-engaging structure 16 and rear right pivot member 54 such that θ₁ and θ₃ are between +75 degrees and +90 degrees, and rotating the front left ground engaging structure 18 and the rear left pivot member 56 such that θ₂ and θ₄ are between −75 degrees and −90 degrees. This will allow the vehicle 10 to move towards either the left or the right side of the vehicle 10, steering in a rearward arc, as shown in FIG. 11.

Alternatively, rotating the front right ground-engaging structure 16 and rear right pivot member 54 such that θ₁ and θ₃ are between +90 degrees and +105 degrees, and rotating the front left ground-engaging assembly 18 and the rear left pivot member 56 such that θ₂ and θ₄ are between −90 degrees and −105 degrees will allow the vehicle 10 to move towards the right side or the left side of the vehicle 10 and steer in a forward arc (not shown).

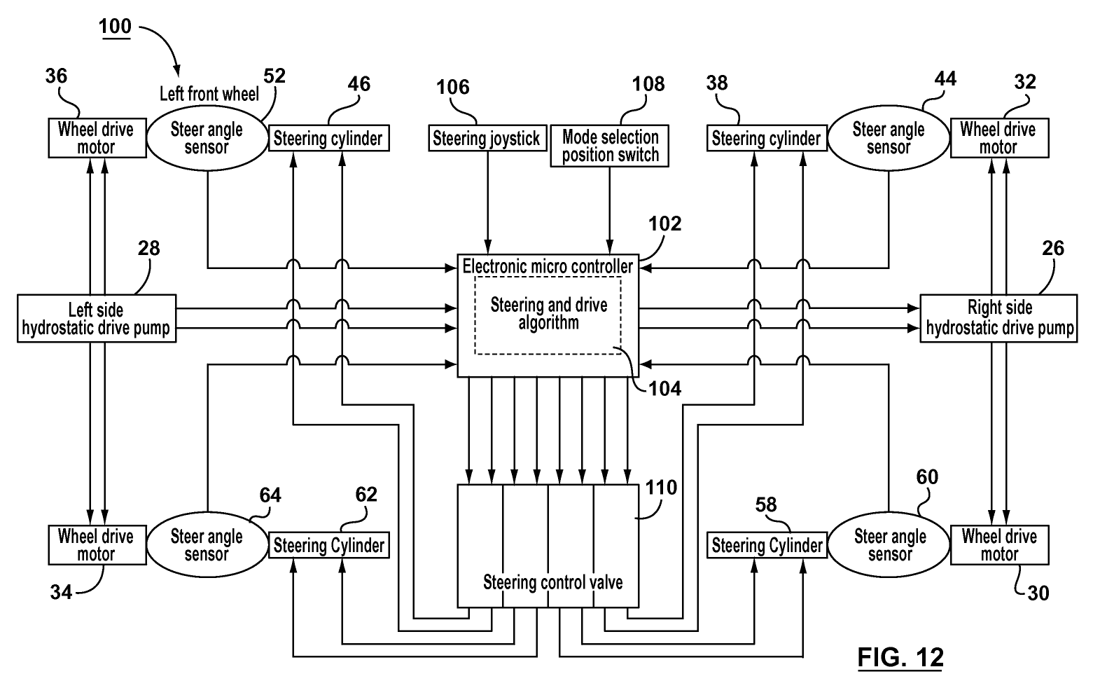

Referring now to FIG. 12, the vehicle 10 is generally controlled by a control system 100, which controls the drive pumps and steering system. According to an embodiment, the control system includes an electronic microcontroller 102 that contains steering and drive algorithms 104, which can be stored in a memory (not shown) or other suitable device. During use of the vehicle 10, the operator Q can select from a variety of steering configurations, such as the various steering configurations described above, using an input device such as the mode selection position switch 108, which is coupled to the microcontroller 102. Based on the selection of the operator Q, the mode selection position switch 108 sends a signal to the microcontroller.

Within each distinct steering configuration, for example the exemplary steering modes described above, the operator Q will have the ability to adjust the pivotable position of the steerable wheels 16a, 18a, 20a, 20b and the rotational speed and direction of the wheel drive motors 30, 32, 34, 36 through the movement of a steer/drive joystick 106 in order to obtain the desired movement of the vehicle 10.

The signal from the joystick 106 will be sent as a steering and propulsion input to the electronic microcontroller 102. Based on the position of the operator joystick 106, the electronic microcontroller 102 will then output an electronic signal to each of the hydrostatic pumps 26, 28 for driving the wheels 16a, 18a, 20a, 20b in forward or reverse drive directions. The microcontroller 102 will also send a control signal to the steering control valve 110. The steering control valve 110 in turn controls the hydraulic actuators 38, 46, 58, 62 for effecting clockwise and/or counterclockwise pivoting of the pivot members 15, 37, 54, 56 of the ground-engaging structures 16, 18, 20 to achieve the desired steering configuration.

The steerable pivot members 15, 37, 54, 56 will pivot in the required direction according to commands provided to the steering control valve 110 by the electronic controller 102. The rotational position of each pivot member 15, 37, 54, 56 will be provided back to the microcontroller 102 by the steer angle sensors 44, 52, 60, 64. The signal from each steer angle sensor 44, 52, 60, 64 will used to continually monitor the rotational position of each pivot members 15, 37, 54, 56 with relation to the steer angle on the joystick input device 106. The electronic microcontroller 1θ₂ will then pivot each pivot member 15, 37, 54, 56 to ensure that each wheel 16a, 18a, 20a, 20b is in the correct rotational position based on the joystick input device 106 and the mode selected by the steering mode switch 104.

While the above description includes a number of exemplary embodiments, many modifications, substitutions, changes, and equivalents will now occur to those of ordinary skill in the art. It is, therefore, to be understood that the appended claims are intended to cover all such modifications and changes.

1. A loader type construction vehicle, comprising:
a) a chassis having a longitudinal axis;
b) a plurality of wheeled ground-engaging structures pivotally coupled to the chassis, each of the plurality of wheeled ground-engaging structures comprising a wheel pivotable about a steering axis and drivable about a drive axis, wherein each of the wheeled ground-engaging structures is shaped and configured so that the wheel of each of the ground-engaging structures can be pivoted from a first angular position in which the drive axis is perpendicular to the longitudinal axis, to a second angular position that is at least 90 degrees from the first angular position; and
c) a steering control system operatively connected to each of the ground-engaging structures for pivoting the wheel of each of the wheeled ground-engaging structures about the steering axis.

2. The vehicle of claim 1, wherein the steering control system is operable to selectively configure the ground-engaging structures into a plurality of different steering configurations and to steer the chassis in each of the plurality of different steering configurations.

3. The vehicle of claim 1, wherein the wheel of each of the ground-engaging structures is pivotable about the steering axis of the wheel by at least 135 degrees.

4. The vehicle of claim 1, wherein each of the plurality of ground-engaging structures comprises a pivot member pivotally coupled to the chassis for movement about the steering axis, a drive motor having a motor housing rigidly coupled to the pivot member and a drive shaft extending along the drive axis, the drive axis being orthogonal to and pivotable about the steering axis, a hub coupled to the drive shaft for releasably securing the wheel thereto, and an actuator coupled to the pivot member and to the chassis for pivoting the pivot member about the steering axis.

5. The vehicle of claim 4, wherein the steering control system comprises:
a) at least one operator input device for receiving operator input;
b) a steering control valve for controlling the movement of the actuator of each of the ground-engaging structures; and
c) an electronic microcontroller for monitoring the operator input and controlling the steering control valve in response to the operator input to configure each of the ground-engaging structures into the plurality of different steering configurations.

6. The vehicle of claim 5, wherein each of the ground-engaging structures includes a feedback sensor for providing a current angular position of each of the plurality of ground-engaging structures to the electronic microcontroller, and wherein the electronic microcontroller compares the operator input with the current angular position of each of the plurality of ground-engaging structures and adjusts the steering control valve in response to the current angular position of each ground-engaging structure to ensure that each ground-engaging structures is in a selected one of the different steering configurations.

7. The vehicle of claim 1, wherein the chassis has a left side, a right side, a front, and a rear, and wherein the plurality of wheeled ground engaging structures includes a front-left ground-engaging structure pivotally coupled to the front of the left side of the chassis, a front-right ground-engaging structure pivotally coupled to the front of the right side of the chassis, a rear-left ground-engaging structure pivotally coupled to the rear of the left side of the chassis and a rear-right ground engaging structure pivotally coupled to the rear of the right side of the chassis.

8. The vehicle of claim 7, wherein the chassis comprises a front transverse frame member having a left end and a right end, wherein the pivot member of front-left ground-engaging structure is pivotally coupled to and extends from the left end of the front transverse frame member at a left-front pivot point located above the wheel of the front-left ground-engaging structure, and wherein the pivot member of the front-right ground engaging structure is pivotally coupled to and extends from the right end of the front transverse frame member at a right front pivot point located above the wheel of the front-right ground-engaging structure, such that the wheels of the front-left and front-right ground engaging structures are offset below the front transverse frame member so that the wheels can be pivoted by a pre-selected amount of rotation without interference from the front transverse frame member.

9. The vehicle of claim 7, wherein the chassis includes a rear transverse frame member having a straight portion defining a rear transverse axis, a curved left end portion and a curved right end portion, wherein the pivot member of the rear-left ground-engaging structure is pivotally coupled to and extends from the curved left end portion of the rear transverse frame member at a left rear pivot point longitudinally offset from the rear transverse axis, wherein the pivot member of the rear-right ground-engaging structure is pivotally coupled to and extends from the curved right end portion of the rear transverse frame member at a right rear pivot point longitudinally offset from the rear transverse axis, such that the wheel of each of the rear-left and rear-right ground engaging structures is longitudinally offset from the rear transverse axis so that the wheel can be pivoted by a pre-selected amount of rotation without interference from the rear transverse frame member.

10. The vehicle of claim 9, wherein the rear transverse frame member is pivotally coupled to the rear transverse frame member by a pivot mount extending along the longitudinal axis of the chassis.

11. The vehicle of claim 3, wherein the steering control system is operable to selectively configure the plurality of ground-engaging structures into at least two steering modes selected from a group of steering modes comprising a front-wheel steering mode, a rear-wheel steering mode, an all-wheel steering mode, a zero turning radius steering mode, a crab steering mode, a side steering mode, and an all wheel side steering mode.

12. The vehicle of claim 11, wherein the steering control system is operable to selectively configure the plurality of ground-engaging structures into at least the zero turning radius steering mode, the crab steering mode, and the side steering mode.

13. The vehicle of claim 1, further comprising a loader arm having a first end secured to and pivotable with respect to the chassis, a second end shaped to receive a work implement, and an arm actuator for pivoting the loader arm with respect to the chassis.

14. The vehicle of claim 13, wherein the loader arm comprises:
a) a first section at the first end pivotally coupled to the chassis;
b) a second section at the second end, the second section being telescopically movable with respect to the first section; and
c) a telescopic actuator for moving the second section with respect to the first section, the telescopic actuator being configured to retract and extend the second section with respect to the first section along a longitudinal axis of the loader arm.

15. The vehicle of claim 7, wherein the drive motors are hydraulic drive motors, wherein the hydraulic drive motors on front-left and rear-left ground-engaging structures are coupled to a first hydraulic pump such that the wheels on the front-left and rear-left ground-engaging structures are driven in the same forward or reverse first direction, and wherein the hydraulic drive motors on front-right and rear-right ground-engaging structures are coupled to a second hydraulic pump such that the wheels on the front-right and rear-right ground-engaging structures are driven in the same forward or reverse second direction, which can be the same or opposite as the forward or reverse first direction.

16. A loader type construction vehicle, comprising:
a) a chassis having a longitudinal axis;
b) a plurality of wheeled ground-engaging structures pivotally coupled to the chassis, each of the plurality of wheeled ground-engaging structures comprising a pivot member pivotally coupled to the chassis for movement about a steering axis, a drive motor having a motor housing rigidly coupled to the pivot member and a drive shaft extending along a drive axis, the drive axis being orthogonal to and pivotable about the steering axis and a hub fixedly coupled to the drive shaft, a wheel releasably secured to the hub, and an actuator coupled to the pivot member and to the chassis for pivoting the pivot member about the steering axis; and
c) a steering control system operatively connected to the actuator of each of the ground-engaging structures for pivoting the pivot member by moving the actuator.

17. The vehicle of claim 16, wherein each of the wheeled ground-engaging structures is shaped and configured so that the wheel of each of the ground-engaging structures can be pivoted by the actuator from a first angular position in which the drive axis is perpendicular to the longitudinal axis to a first position that is at least 90 degrees from the second angular position.

18. A loader vehicle comprising:
a) a chassis;
b) a plurality of wheeled ground-engaging structures pivotally coupled to the chassis for supporting and steering the loader vehicle;
c) a loader arm having a longitudinal arm axis, the loader arm comprising a first section secured to and pivotable with respect to the chassis and a second section shaped to receive a work implement, the second section being telescopically movable with respect to the first section;
d) a telescopic actuator for moving the second section with respect to the first section, the telescopic actuator being configured to retract and extend the second section with respect to the first section along the longitudinal arm axis; and
e) an arm actuator for pivoting the loader arm with respect to the vehicle.

19. The loader vehicle of claim 18, wherein the first section of the loader arm has a hollow interior and a straight portion extending along the longitudinal arm axis, the second section of the loader arm defines a hollow interior shaped to slidably receive the straight portion of the first section, and the telescopic actuator is located within the hollow interior of the first section and the second section for extending and retracting the second section relative to the first section along the longitudinal arm axis.

20. The loader vehicle of claim 18, wherein the first section includes a first curved portion configured to allow the work implement to move forward of the vehicle and below a ground surface on which the vehicle is positioned.
